(19) United States
(12) Patent Application Publication
(10) Pub. No.: US 2013/0038664 A1
(43) Pub. Date: Feb. 14, 2013

(54) INK COMPOSITION, RECORDING UNIT AND INK JET RECORDING APPARATUS USING THE SAME, AND RECORDED MATERIAL

(71) Applicants: Takayoshi KAGATA, Shiojiri-shi (JP); Tomohiro Sayama, Matsumoto-shi (JP)

(72) Inventors: Takayoshi KAGATA, Shiojiri-shi (JP); Tomohiro Sayama, Matsumoto-shi (JP)

(73) Assignee: SEIKO EPSON CORPORATION

(21) Appl. No.: 13/569,503

(22) Filed: Aug. 8, 2012

(30) Foreign Application Priority Data
Aug. 10, 2011 (JP) 2011-174868

(51) Int. Cl. B41J 2/135; C09D 11/02

(52) U.S. Cl. 347/44; 106/31.13; 347/105

(57) ABSTRACT

An aspect of the invention provides an ink composition ejected from a nozzle having a step, the ink composition containing at least any one of a first water-soluble organic solvent and a second water-soluble organic solvent, wherein the first water-soluble organic solvent exhibits a surface tension of 30 mN/m or lower at 20° C., an aqueous solution of the second water-soluble organic solvent of 10 mass % exhibits a surface tension of 50 mN/m or lower at 20° C., and the total content of the first water-soluble organic solvent and the second water-soluble organic solvent is 0.15 mass % or higher.

Priority is claimed under 35 U.S.C. §119 to Japanese Application No. 2011-174868 filed on Aug. 10, 2011, is hereby incorporated by reference in its entirety.

### BACKGROUND

1. Technical Field

The present invention relates to an ink composition, a recording unit and ink jet recording apparatus using the ink composition, and a recorded material.

2. Related Art

In well-known ink jet recording apparatuses, fine droplets of an ink composition are ejected from a nozzle of an ink jet recording head to form images and characters.

For example, JP-A-2006-27193, JP-A-2010-23362, Japanese Patent No. 3972926, and JP-A-2006-181827 disclose ink jet ink compositions containing various components such as colorants, organic solvents, and surfactants.

In recent years, demands for formation of high-quality images have induced wide development of high-resolution ink jet recording heads. For instance, in order to provide such high-resolution ink jet recording heads, the number of nozzles of a nozzle plate included in a recording head is increased. For example, JP-A-2006-181827 discloses a technique to form nozzles by etching. The technique to form nozzles by etching enables precise formation of nozzles with small intervals provided therebetween, which enables a plurality of nozzles to be formed in a nozzle plate.

Some of the nozzles described above have a diameter which becomes decreased in the direction of ink ejection to form a multistep structure (step), which enhances performance in ejection of ink. In ejection of ink from the nozzle having such a structure, air bubbles are likely to be taken into the nozzle during the ejection in some cases, resulting in a decrease in ejection stability of an ink.

### SUMMARY

An advantage of some aspects of the invention is that it provides an ink composition which exhibits excellent ejection stability to overcome at least part of the disadvantages described above.

Some aspects of the invention have the following advantages and applications.

According to a first aspect of the invention, an ink composition ejected from a nozzle having a step is provided, the ink composition containing at least one of a first water-soluble organic solvent and a second water-soluble organic solvent, wherein the first water-soluble organic solvent exhibits a surface tension of 30 mN/m or lower at 20° C., an aqueous solution containing the second water-soluble organic solvent of 10 mass % exhibits a surface tension of 50 mN/m or lower at 20° C., and the total content of the first water-soluble organic solvent and the second water-soluble organic solvent is 0.15 mass % or higher.

The ink composition according to the first aspect of the invention exhibits excellent ejection stability.

It is preferable that the nozzle is formed in a nozzle plate and the nozzle plate is composed of crystalline silicon.

It is preferable that the nozzle plate is provided to a recording head, and the recording head has a nozzle density of 300 dpi or higher and is a piezoelectric type.

It is preferable that the ink composition may additionally contain at least one different first water-soluble organic solvent.

In the ink composition, the first water-soluble organic solvent may be at least any one of 2-ethyl-1,3-hexanediol and 1,2-hexanediol.

According to a second aspect of the invention, a recording unit is provided, the recording unit including the ink composition described above, a recording head; and a nozzle formed in the recording head and having a step, the ink composition being ejected from the nozzle.

The recording unit according to the second aspect of the invention uses the ink composition described above, which can enhance ejection stability of the ink.

According to a third aspect of the invention, an ink jet recording apparatus is provided, the ink jet recording apparatus including a nozzle having a step, wherein the ink composition described above is ejected from the nozzle for recording.

The ink jet recording apparatus according to the third aspect of the invention uses the ink composition described above, which can enhance ejection stability of the ink.

According to a fourth aspect of the invention, a recorded material is provided, the recorded material being formed by the ink jet recording apparatus described above.

### BRIEF DESCRIPTION OF THE DRAWINGS

The invention will be described with reference to the accompanying drawings, wherein like numbers reference like elements.

FIG. 1 is a perspective view illustrating the configuration of a printer of an embodiment of the invention.

FIG. 2 is a schematic exploded perspective view illustrating the configuration of a recording head of an embodiment of the invention.

FIG. 3 is a schematic cross-sectional view partially illustrating the internal configuration of the recording head of the embodiment of the invention.

FIG. 4 is an enlarged cross-sectional view partially illustrating a nozzle of the recording head of the embodiment of the invention.

### DESCRIPTION OF EXEMPLARY EMBODIMENTS

Preferred embodiments of the invention will be hereinafter described. Embodiments described below are examples of the invention. The invention should not be limited to the following embodiments and can be variously modified within the scope of the invention.

### 1. Ink Composition

An ink composition of an embodiment of the invention is ejected from a nozzle having a step and contains at least one of a first water-soluble organic solvent and a second water-soluble organic solvent. Components contained in the ink composition of this embodiment will now be described.

### 1.1. First Water-Soluble Organic Solvent

The first water-soluble organic solvent exhibits a surface tension of 30 mN/m or lower at 20° C.

The first water-soluble organic solvent can significantly enhance ejection stability of the ink composition to be ejected from a nozzle having a step which will be described later. Although the reason for the enhancement of the ejection stability has been still studied, it is believed that the following mechanism contributes to the enhancement of the ejection stability.

In general, after droplets of an ink composition (simply referred to as “ink droplets”, where appropriate) have been ejected from a nozzle, components, such as a surfactant, align on a surface of a meniscus remaining in the nozzle until subsequent ink droplets are ejected from the same nozzle, which appropriately maintain the shape of the meniscus of the ink. This can reduce a variation in a position where the ink droplets land, leading to enhancement of ejection stability.

However, ejection of ink droplets from a nozzle having a step, which will be descried later, is likely to cause air bubbles to be taken into the nozzle. Thus, the air bubbles in the nozzle prevent components, such as a surfactant, from aligning on a surface of a meniscus by the time that subsequent ink droplets are ejected from the same nozzle. It is accordingly believed that use of the nozzle having a step prevents the shape of the meniscus from being appropriately maintained with the result that ejection stability is likely to be decreased.

In this case, it is believed that the first water-soluble organic solvent can effectively adjust a surface tension of the meniscus within a micro time (e.g., 100 microseconds) corresponding to an interval between a series of ejection of ink droplets in a continuous ejection of the ink droplets, so that the intake of air bubbles into the nozzle can be reduced. Hence, the first water-soluble organic solvent can significantly enhance ejection stability of the ink composition to be ejected from the nozzle having a step which will be described later.

In the case of using the ink composition of this embodiment in a piezoelectric recording head which exhibits high-density (300 dpi or higher) nozzle resolution (density of nozzles in a nozzle plate), the first water-soluble organic solvent and the second water-soluble organic solvent (described later), which are contained in the ink composition, serve to reduce defective ejection due to crosstalk.

The term “crosstalk” herein means a phenomenon in which application of voltage to a piezoelectric device corresponding to a nozzle A of a piezoelectric recording head for ink ejection causes unwanted application of voltage to a piezoelectric device corresponding to a nozzle B which adjoins the nozzle A and is not supposed to eject ink. Especially, since a distance between nozzles is small in a high-density recording head, the crosstalk is easily caused. The occurrence of the crosstalk may cause ink droplets to be ejected from a nozzle which is not supposed to eject the ink droplets, which causes defective ejection.

The first water-soluble organic solvent and the second water-soluble organic solvent (described later) can effectively contribute to control of an ejection amount of ink droplets in response to a driving frequency of a piezoelectric recording head, whereas the reason for this phenomenon has been still studied. Use of the first water-soluble organic solvent therefore enables an ejection amount of ink droplets to be easily controlled.

The first water-soluble organic solvent has a surface tension of 30 mN/m or lower, preferably ranging from 20 mN/m to 30 mN/m, and more preferably 25 mN/m to 30 mN/m at 20° C. The first water-soluble organic solvent exhibiting a surface tension of 30 mN/m or lower can enhance ejection stability of the ink to be ejected from the nozzle having a step. In contrast, the first water-soluble organic solvent exhibiting a surface tension exceeding 30 mN/m is likely to decrease ejection stability of the ink to be ejected from the nozzle having a step. The surface tension of the first water-soluble organic solvent can be determined by measuring a static surface tension with a surface tensiometer. Examples of the surface tensiometer include an automatic surface tensiometer CBVP-A3 (manufactured by Kyowa Interface Science Co., Ltd) based on Wilhelmy method and measurement apparatuses having equivalent measurement accuracy.

Examples of the first water-soluble organic solvent (surface tension of 30 mN/m or lower at 20° C.) include 2-ethyl-1,3-hexanediol (29 mN/m), 1,2-hexanediol (27 mN/m), tetraethylene glycol monobutyl ether (29 mN/m), ethanol (23 mN/m), 1-propanol (24 mN/m), 2-propanol (22 mN/m), 1-butanol (25 mN/m), isobutyl alcohol (23 mN/m), tert-butyl alcohol and isopentyl alcohol (24 mN/m), 2-methyl-2,4-pentanediol (27 mN/m), dipropylene glycol-n-propyl ether, propylene glycol-n-propyl ether, dipropylene glycol methyl ether acetate, diethylene glycol monobutyl ether, and ethylene glycol ether acetate. Parenthesized values each represent a surface tension at 20° C. These first water-soluble organic solvents may be used alone or in combination. Among those solvents, preferred are 1,2-hexanediol and 2-ethyl-1,3-hexanediol, and most preferred is 1,2-hexanediol. 2-ethyl-1,3-hexanediol provides a larger effect as compared to 1,2-hexanediol in use in the same amount and is preferred in terms of providing a satisfactory effect in use in a small amount.

Examples of solvents which exhibit a surface tension out of the above-mentioned ranges (i.e., solvents exhibiting a surface tension exceeding 30 mN/m at 20° C.) include 1,5-pentanediol, 3-methyl-1,3-butanediol, propylene glycol, ethylene glycol, polypropylene glycol, dipropylene glycol, glycerin, diethylene glycol monoethyl ether, and diethylene glycol monoethyl ether acetate.

The total content of the first water-soluble organic solvent and the second water-soluble organic solvent, which will be described later, is 0.15 mass % or higher, preferably in the range of 0.15 mass % to 10 mass %, more preferably 0.2 mass % to 10 mass %, and further preferably 0.5 mass % to 6 mass %. At the total content of 0.15 mass % or higher of the first water-soluble organic solvent and the second water-soluble organic solvent, ejection stability of the ink composition to be ejected from the nozzle having a step, which will be hereinafter described, can be significantly enhanced. In contrast, at the total content below 0.15 mass % of the first water-soluble organic solvent and the second water-soluble organic solvent of, ejection stability of the ink composition to be ejected from the nozzle having a step, which will be hereinafter described, is likely to be decreased.

The term “total content of the first water-soluble organic solvent and the second water-soluble organic solvent” herein refers to the content of one solvent in the case where the ink composition is composed of one of the two solvents or the total content of the two solvents in the case of the ink composition is composed of the two solvents.

In the case of using 1,2-hexanediol as the first water-soluble organic solvent, the 1,2-hexanediol content is preferably 2.5 mass % or higher. Use of 1,2-hexanediol at a predetermined amount provides various advantageous effects, such as an increase in permeability to a recording medium, an improvement in ejection stability involving stable waveform characteristics of a recording apparatus, and enhancement of solubility of water-insoluble solvents.

Use of 2-ethyl-1,3-hexanediol can provide advantageous effects, such as an increase in permeability to a recording medium and enhancement of ejection stability. The 2-ethyl-1,3-hexanediol content is not specifically limited, but preferably not less than 0.01 mass % and less than 2.5 mass %, more preferably from 0.03 mass % to 2.0 mass %.

The first water-soluble organic solvent may be used alone or in combination with the second water-soluble organic solvent which will be described later.

### 1.2. Second Water-Soluble Organic Solvent

In the case where the second water-soluble organic solvent of 10 mass % is contained in an aqueous solution, the aqueous solution of the second water-soluble organic solvent exhibits a surface tension of 50 mN/m or lower at 20° C. The surface tension of the second water-soluble organic solvent is measured by using an aqueous solution prepared by dissolving the second water-soluble organic solvent of 10 mass % in water of 90 mass %. The surface tension of the aqueous solution of the second water-soluble organic solvent is measured with the same apparatus as used in the measurement of the surface tension of the first water-soluble organic solvent through the same process.

The second water-soluble organic solvent can significantly enhance the ejection stability of the ink composition to be ejected from the nozzle having a step which will be described later. This advantage is provided for the same reason as described for the first water-soluble organic solvent, and repeated description is therefore omitted.

Examples of the second water-soluble organic solvent include 1,6-hexanediol, 1,3-octanediol, and 2,5-dimethyl-2,5-hexanediol which are in the form of solid at normal temperature (20° C.). An aqueous solution of 1,6-hexanediol of 10 mass % exhibits a surface tension of 43.6 mN/m at 20° C. The second water-soluble organic solvents may be used alone or in combination.

The second water-soluble organic solvent may be used alone or in combination with the first water-soluble organic solvent.

### 1.3. Other Components

The ink composition of this embodiment may contain other components than the solvents described above. Components which can be added to the ink composition will be now specifically described.

### 1.3.1. Other Water-Soluble Organic Solvent

The ink composition of this embodiment may contain other water-soluble organic solvents than the first and second water-soluble organic solvents.

Examples of such other water-soluble organic solvents include polyhydric alcohols and pyrrolidone derivatives. Such water-soluble organic solvents may be used alone or in combination.

Examples of polyhydric alcohols include ethylene glycol, diethylene glycol, triethylene glycol, polyethylene glycol, polypropylene glycol, dipropylene glycol, propylene glycol, butylene glycol, 1,2-butanediol, 1,2-pentanediol, 1,5-pentanediol, 1,2-heptanediol, 1,2-octanediol, 1,2,6-hexanetriol, thioglycol, hexylene glycol, glycerin, trimethylolethane, and trimethylolpropane. These polyhydric alcohols can prevent the ink composition from being dried and eliminate the occurrence of nozzle clogging.

Examples of pyrrolidone derivatives include N-methyl-2-pyrrolidone, N-ethyl-2-pyrrolidone, N-vinyl-2-pyrrolidone, 2-pyrrolidone, and 5-methyl-2-pyrrolidone.

### 1.3.2. Surfactant

The ink composition of this embodiment may contain a surfactant. The ink composition containing the surfactant can exhibit proper surface tension and interfacial tension with respect to ink-contacting components of printer, such as a nozzle. Use of such an ink composition in ink jet recording apparatuses can accordingly enhance ejection stability. Addition of the surfactant to the ink composition enables the ink to uniformly spread on a recording medium without uneven color density and the occurrence of ink bleed.

Preferred examples of the surfactant which provides such advantageous effects include nonionic surfactants. Preferred nonionic surfactants are silicone surfactants and/or acetylenic glycol surfactants.

Preferred silicone surfactants are polysiloxane compounds such as polyether-modified organosiloxane. Specific examples of the silicone surfactants include BYK-306, BYK-307, BYK-333, BYK-341, BYK-345, BYK-346, and BYK-348 (names of products manufactured by BYK Japan KK); and KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (names of products manufactured by Shin-Etsu Chemical Co., Ltd.). In the case where the ink composition contains the silicone surfactant, the silicone surfactant content is preferably in the range of 0.1 mass % to 2 mass % relative to the total mass of the ink composition.

Examples of the acetylenic glycol surfactants include Surfynols 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, and DF110D (names of products manufactured by Air Products and Chemicals, Inc.); Olfines B, Y, P, A, STG, SPC, E1004, E1010, PD-001, PD-002W, PD-003, PD-004, EXP.4001, EXP.4036, EXP.4051, AF-103, AF-104, AK-02, SK-14, and AE-3 (names of products manufactured by Nissin Chemical Industry Co., Ltd.); and Acetylenols E00, E00P, E40, and E100 (names of products manufactured Kawaken Fine Chemicals Co., Ltd.). In the case where the ink composition contains the acetylenic glycol surfactant, the acetylenic glycol surfactant content is preferably in the range of 0.1 mass % to 2 mass % relative to the total mass of the ink composition.

Anionic surfactants, nonionic surfactants, and amphoteric surfactants may be added in place of the surfactants described above.

### 1.3.3. Water

The ink composition of this embodiment preferably contains water. Preferred examples of the water include pure water and ultrapure water, such as ion-exchanged water, ultra-filtered water, reverse osmosis water, and distilled water. Furthermore, these types of water are preferably subjected to sterilization treatment by ultraviolet irradiation or hydrogen peroxide addition, which prevents generation of funguses and bacteria over a long period.

### 1.3.4. Colorant

The ink composition of this embodiment may contain a colorant. Examples of the colorant include, but are not limited to, dyes, pigments, glitter pigments, and white colorants.

The colorant content is preferably 1 mass % to 20 mass %, more preferably 1 mass % to 15 mass % relative to the total mass of the ink composition.

Preferably usable dyes and pigments are disclosed in U.S. Patent Application Publication Nos. 2010/0086690 and 2005/0235870 and WO 2011/027842. Preferred are pigments rather than dyes. Preferred pigments are organic pigments in terms of preservation stability such as light resistance, weather resistance, and gas resistance.

Specific examples of pigments include azo pigments such as insoluble azo pigments, condensed azo pigments, azo lakes, and chelate azo pigments; polycyclic pigments such as phthalocyanine pigments, perylene and perinone pigments, anthraquinone pigments, quinacridone pigments, dioxane pigments, thioindigo pigments, isoindolinone pigments, and quinophthalone pigments; dye chelates; dye lakes; nitro pigments; nitroso pigments; aniline black; and daylight fluorescent pigments. These pigments may be used alone or in combination.

Examples of usable dyes include various dyes which can be normally used in ink jet recording, such as direct dyes, acid dyes, food colors, basic dyes, reactive dyes, disperse dyes, vat dyes, soluble vat dyes, and reactive disperse dyes.

Examples of the white colorants include metallic oxides, barium sulfate, and calcium carbonate. Examples of the metallic oxides include titanium dioxide, zinc oxide, silica, alumina, and'magnesium oxide. The white colorants may be hollow particles, and any traditional hollow particle can be used without limitation. For instance, preferably usable hollow particles are disclosed in U.S. Pat. No. 4,880,465.

The ink composition of this embodiment may contain any glitter pigment which can adhere to a medium while exhibiting glitter. Examples of such a glitter pigment include alloys of at least one material selected from the group consisting of aluminum, silver, gold, platinum, nickel, chromium, tin, zinc, indium, titanium, and copper; and pearl pigments having pearl gloss. Representative examples of the pearl pigments include pigments exhibiting pearl gloss and interference gloss, such as titanium dioxide-coated mica, fish scale guanine, and bismuth oxychloride. The glitter pigment may be subjected to surface treatment to avoid a reaction with water. The ink composition containing the glitter pigment enables formation of images exhibiting excellent glitter.

In the case where the ink composition of this embodiment contains silver particles as the glitter pigment, the silver particles are fed in the form of, e.g., the following aqueous dispersion of the silver particles in synthesis of the ink composition. In this case, the silver particles may be fed in the form of powder provided that their dispersibility can be secured, in place of the form of the aqueous dispersion.

The aqueous dispersant of silver particles contains silver particles and water. In this embodiment, the silver particles contained in the aqueous dispersant are primarily composed of silver. The silver particles may contain accessory ingredients such as other metals, oxygen, and carbon. For example, the silver purity of the silver particles may be 50% or higher. The silver particles may be alloys of silver and other metals. The silver particles may be contained in the aqueous dispersant in the form of colloid (particle colloid). The colloidal silver particles are dispersed with further enhanced dispersibility, which contributes to, for instance, enhancement of the preservation stability of the aqueous dispersion of silver particles and the ink composition containing the aqueous dispersion.

### 1.3.5. Other Components

The ink composition of this embodiment may contain a resin. Examples of the rein include traditional resins such as acrylic resins, styrene-acrylic resins, fluorene resins, urethane resins, polyolefin resins, rosin-modified resins, terpene resins, polyester resins, polyamide resins, epoxy resins, vinyl chloride resins, vinyl chloride-vinyl acetate copolymers, and ethylene-vinyl acetate resins; and polyolefin wax. These resins may be used alone or in combination. These resins can enhance the fixability of the ink composition to a recording medium, increase abrasion resistance, and enhance dispersibility of the colorant contained in the ink composition.

Furthermore, the ink composition of this embodiment may contain a pH adjuster, a preservative, a fungicide, a corrosion inhibitor, and a chelating agent. Addition of these components to the ink composition of this embodiment can further improve characteristics of the ink composition in some cases.

Examples of the pH adjuster include potassium dihydrogen phosphate, disodium hydrogen phosphate, sodium hydroxide, lithium hydroxide, potassium hydroxide, ammonium, diethanolamine, triethanolamine, triisopropanolamine, potassium carbonate, sodium carbonate, and sodium hydrogen carbonate.

Examples of the preservative and fungicide include sodium benzoate, sodium pentachlorophenolate, sodium-2-pyridinethiol-1-oxide, sodium sorbate, sodium dehydroacetate, and 1,2-dibenzisothiazolin-3-one. Examples of commercially available preservative and fungicides include PROXELs XL2 and GXL (names of products manufactured by Arch Chemicals, Inc.) and Denicides CSA and NS-500W (names of products manufactured by Nagase ChemteX Corporation).

Examples of the corrosion inhibitor include benzotriazole.

Examples of the chelating agent include ethylenediaminetetraacetic acid and salts thereof (for example, disodium dihydrogen ethylenediamine tetraacetate).

The ink composition of this embodiment can be prepared as in preparation of traditional pigment inks with well-known apparatuses such as a ball mill, a sand mill, an attritor, a basket mill, and a roll mill. In the preparation of the ink composition, membrane filters and mesh filters are preferably used to remove coarse particles.

### 1.4. Physical Properties of Ink Composition

The ink composition of this embodiment preferably has a viscosity of 3 mPa·s to 10 mPa·s, more preferably 3 mPa·s to 6 mPa·s at 20° C. The ink composition having a viscosity within the above ranges at 20° C. can be ejected from a nozzle in an appropriate amount and further prevented from being ejected in an unintended direction and splashing, which enables the ink composition to be desirably used in ink jet recording apparatuses. The viscosity of the ink composition can be measured with an oscillational viscometer VM-100AL (SEKONIC CO., LTD.) while the ink composition is kept at 20° C.

The ink composition of this embodiment preferably has a surface tension of 20 mN/m to 40 mN/m, more preferably 25 mN/m to 35 mN/m at 20° C. The ink composition having a surface tension within these ranges can improve the ejection stability of the ink and secure appropriate wettability to a recording medium. The surface tension of the ink composition can be measured with the same apparatus as used in the measurement of surface tension of the first water-soluble organic solvent.

### 2. Recording Unit and Ink Jet Recording Apparatus

A recording unit of an embodiment of the invention includes the ink composition described above, a recording head, and a nozzle formed in the recording head and having a step, the ink composition being ejected from the nozzle. The recording unit of this embodiment is preferably an ink jet recording unit.

An ink jet recording apparatus of an embodiment of the invention includes a nozzle having a step, and the ink composition described above is ejected from the nozzle for recording.

An ink jet recording apparatus provided with an ink jet recording unit will now be described as a specific embodiment.

In this embodiment, an ink jet printer (hereinafter simply referred to as “printer”) will be described as an example of the ink jet recording apparatus. The details of the printer will now be described with reference to the drawings. In the drawings, scales of components are appropriately changed to illustrate the components in a visible scale. The invention should not be limited to the following configurations.

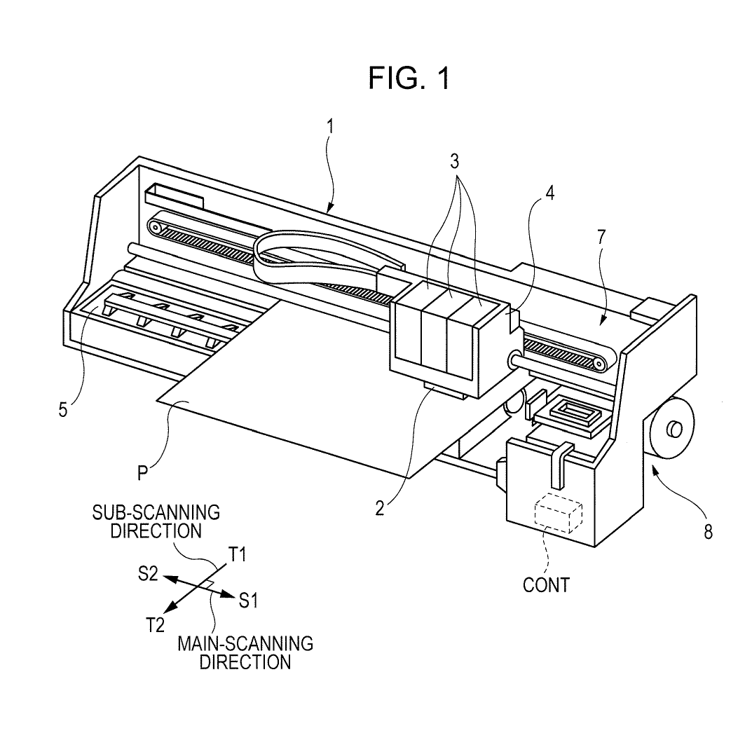

FIG. 1 is a perspective view illustrating the configuration of a printer 1 of this embodiment. The printer 1 illustrated in FIG. 1 is a serial printer. The term “serial printer” means a printer including a carriage which moves in a predetermined direction and a recording head provided to the carriage, and the movement of the carriage allows the recording head to move to eject ink droplets onto a recording medium.

With reference to FIG. 1, the printer 1 includes a carriage 4 to which a recording head 2 is provided and ink cartridges 3 are removably attached, a platen 5 which is provided below the recording head 2 and on which a recording medium P is transported, a carriage-moving mechanism 7 to move the carriage 4 in the width direction of the recording medium P, and a medium-feeding mechanism 8 to transport the recording medium P in a medium-feeding direction.

In addition, the printer 1 includes a controller CONT which controls the general operation of the printer 1. The width direction of the recording medium P corresponds to a main-scanning direction (recording head-scanning direction). The medium-feeding direction corresponds to a sub-scanning direction (direction vertical to the main-scanning direction).

The controller CONT can control the timing of the operation of the carriage 4, recording head 2, carriage-moving mechanism 7, and medium-feeding mechanism 8 and bring these components into cooperation.

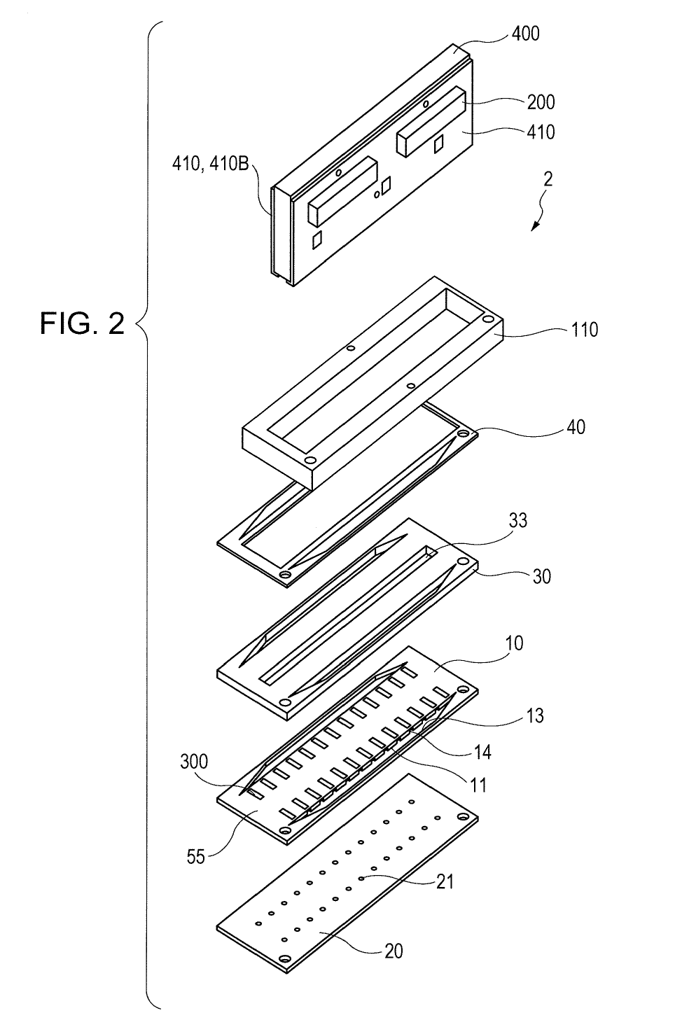

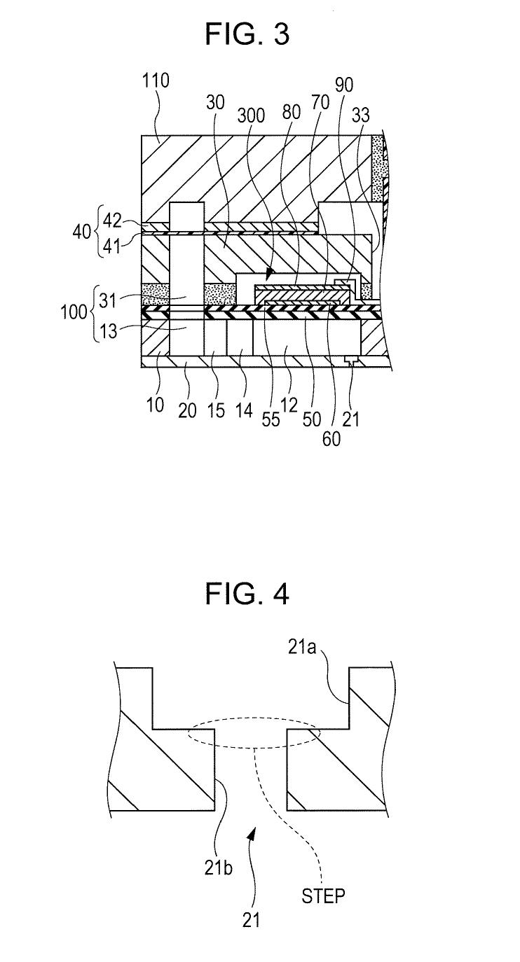

FIG. 2 is a schematic exploded perspective view illustrating the configuration of the recording head 2. FIG. 3 is a schematic cross-sectional view partially illustrating the internal configuration of the recording head 2. FIG. 4 is an enlarged cross-sectional view partially illustrating the nozzle 21 of the recording head 2.

With reference to FIG. 2, the recording head 2 includes a channel-forming substrate 10, a nozzle plate 20, a protective substrate 30, a compliance substrate 40, a head case 11, and a planar member 400.

In this embodiment, the channel-forming substrate 10 is composed of monocrystalline silicon having a surface orientation of (110), and an elastic film 50 composed of silicon dioxide is formed on one surface of the channel-forming substrate 10. The channel-forming substrate 10 may be composed of other materials than monocrystalline silicon, such as, metals and ceramics.

The channel-forming substrate 10 has two lines of multiple pressure-generating chambers 12 defined by partitions 11 and aligned in parallel in the width direction of the channel-forming substrate 10. A communication portion 13 is formed in a peripheral region of each pressure-generating chamber 12 in its longitudinal direction, and an ink-supplying channel 14 and a communication channel 15 are formed for each pressure-generating chamber 12. The communication portion 13 is in communication with the pressure-generating chamber 12 through the ink-supplying channel 14 and the communication channel 15. The connection portions 13 are in communication with reserving portions 31 of the protective substrate 30, which will be described later, to form reservoirs 100 which serve as common ink chambers for the individual lines of the pressure-generating chambers 12. Each ink-supplying channel 14 has a width smaller than that of each pressure-generating chamber 12 to maintain constant channel resistance of ink which flows from the communication portion 13 into the pressure-generating chamber 12.

The opening-side surface of the channel-forming substrate 10 is bonded to the nozzle plate 20 with an adhesive, a thermally adhesive film, or other materials, the nozzle plate 20 having nozzles 21 that are in communication with the vicinities of ends of the pressure-generating chambers 12, and the ends being opposite to the ink-supplying channels 14. In this embodiment, since the channel-forming substrate 10 has the two lines of pressure-generating chambers 12 aligned in parallel, one recording head 2 has two lines of nozzles 21 aligned in parallel. For example, the nozzle plate 20 is composed of glass-ceramic materials, monocrystalline silicon, or stainless steel.

The nozzle plate 20 is preferably composed of crystalline silicon, such as monocrystalline silicon or polycrystalline silicon, among those materials. The nozzle plate 20 is more preferably composed of monocrystalline silicon. Nozzle plates composed of crystalline silicon can be processed through traditional etching processes (such as wet etching and dry etching) with high accuracy, and nozzles are formed by combination of these etching processes in many cases. Thus, use of nozzle plates composed of crystalline silicon enables nozzles to be formed in high density (e.g., nozzle density of 300 dpi or higher) as compared to formation of nozzles by punching or other techniques. In addition, the nozzle plates composed of crystalline silicon are suitable for formation of a nozzle having a step which will be described later.

The opening of each nozzle 21 has a diameter which varies stepwise to enhance ejection stability of ink droplets, and each nozzle 21 therefore has a multistep structure having two or more steps. For instance, as illustrated in FIG. 4, each nozzle 21 has a large-diameter portion 21a and a small-diameter portion 21b having a diameter smaller than that of the large-diameter portion 21a. The large-diameter portion 21a and the small-diameter portion 21b are formed in sequence (order of the large-diameter portion 21a and the small-diameter portion 21b) in a direction in which ink droplets are ejected.

The term “step of a nozzle” herein refers to a joint between portions having different diameters in one nozzle 21. In the step, difference in level drastically changes as in stairs, and the joint between portions having different diameters preferably defines an angle of 70° or higher, more preferably 80° or higher, further preferably 70° to 110°, and still further preferably 80° to 100° (approximately 90° in FIG. 4). Structures traditionally used have a taper at an angle of approximately 150° and are not therefore the step.

An elastic film 50 is formed on the other side of the channel-forming substrate 10, and an insulating film 55 is formed on the elastic film 50, the other surface being opposite to the opening-side surface. Furthermore, a lower electrode film 60, a piezoelectric layer 70, and an upper electrode film 80 are laminated on the insulating film 55 to form piezoelectric devices 300 as a pressure-generating device in this embodiment. The piezoelectric devices 300 are portions each including the lower electrode film 60, the piezoelectric layer 70, and the upper electrode film 80.

The upper electrode films 80 as individual electrodes of the piezoelectric electrodes 300 are connected to lead electrodes 90 extending onto the insulating film 55. The lead electrodes 90 have ends connected to the upper electrodes 80 and have the other end extending to a region between lines of piezoelectric devices 300 aligned in parallel.

The protective film 30 has the reserving portions 31 which function as at least part of the reservoirs 100 and is bonded so as to overlie the channel-forming substrate 10 which underlies the piezoelectric devices 300 described above. In this embodiment, the reserving portions 31 penetrate the protective substrate 30 in its thickness direction so as to extend in the width direction of the pressure-generating chambers 12 and are in communication with the communication portions 13 of the channel-forming substrate 10 to form the reservoirs 100 as the common ink chambers for individual lines of the pressure-generating chambers 12.

The protective substrate 30 has a through-hole 33 which penetrates the protective substrate 30 in its thickness direction.

In this embodiment, the through-hole 33 is formed between two piezoelectric device-holding portions 32. The vicinities of ends of the lead electrodes 90 extending from corresponding piezoelectric devices 300 are exposed inside the through-hole 33.

The compliance substrate 40 includes a sealing film 41 and a fixing plate 42 and is bonded to a surface of the protective substrate 30, and a head case 110 as a holding member is attached to a surface of the compliance substrate 40.

A chip on film (COF) substrate 410 is used as a printed circuit board, and the COF substrate 410 is provided with driving circuits 200 which drive the piezoelectric devices 300 to, thereby forming an elastic circuit board. The lower end of the COF substrate 410 is connected to the lead electrodes 90, and the COF substrate 410 substantially vertically stands and is bonded to a side surface of a plate 400 as a supporting member. In this embodiment, the plate 400, the COF substrate 410, and the driving circuits 200 constitute the circuit board. In the recording head 2, the channel-forming substrate 10 has the two lines of pressure-generating chambers 12 aligned in parallel, and two lines of the piezoelectric devices 300 are accordingly formed, the piezoelectric devices 300 being aligned in parallel in the width direction of the pressure-generating chambers 12 (width direction of the piezoelectric devices 300).

In the structure described above, i.e., the piezoelectric recording head 2, ink is introduced from ink-introducing openings connected to the ink cartridges 3 to fill the inside of the recording head 2 from the reservoirs 100 to the nozzles 21, and then a voltage is applied between the lower electrode film 60 and the upper electrode film 80 of the corresponding pressure-generating chamber 12 in response to a recording signal from the driving circuits 200. Then, the elastic film 50, the piezoelectric film 55, the lower electrode 60, and the piezoelectric layer 70 are deformed in the manner of deflection to increase pressure inside the pressure-generating chamber 12, thereby ejecting ink droplets from the nozzle 21. In this manner, a predetermined image can be formed on the recording medium P.

The ink jet recording apparatus of this embodiment is preferably used for recording to a recording medium having a micro-porous layer with the ink composition described above. The term “recording medium having a micro-porous layer” refers to a material having an ink-ejected surface which is primarily composed of inorganic particles (for example, silica and alumina) and on which a liquid penetrates into gaps between inorganic particles or pores of inorganic particles or refers to a material having an ink-ejected surface which is primarily composed of a swellable resin which is swollen by ink droplets with the result that components contained in the ink droplets penetrate into pores formed by the swelling. In recording to the recording medium having a micro-pore layer, the first or second water-soluble organic solvent functions as a penetrant to promote desirable penetration of pigments into the recording medium having a micro-pore layer, which enables the pigments to densely remain on a surface of the recording medium. The densely remaining pigments exhibit effects of satisfactory weather resistance and coloration.

The ink jet recording apparatus of this embodiment has the nozzle having the step and therefore exhibits excellent ejection stability of ink droplets. In addition, the ink composition described above is used in the ink jet recording apparatus of this embodiment, which enables the ink to be ejected with high stability.

### 3. Examples

The invention will now be described further in detail with reference to Examples and Comparative Examples, whereas the invention should not be limited to Examples.

### 3.1. Preparation of Ink Composition

Components were blended in amounts shown in Tables 1 and 2 and then stirred. The resulting products were filtered by a metallic filter having a pore diameter of 5 μm and degassed with a vacuum pump to prepare ink compositions used for the following evaluation.

In Tables 1 and 2, the unit for amounts of the components of the ink compositions is mass %. In Tables 1 and 2, parenthesized values in organic solvents represent surface tensions (mN/m) of the organic solvents. The surface tensions of the organic solvents were measured at 20° C. with an automatic surface tensiometer CBVP-A3 (manufactured by Kyowa Interface Science Co., Ltd). Among the organic solvents, since 1,6-hexanediol and trimethylolpropane are in the form of solid at normal temperature (20° C.), 1,6-hexanediol and trimethylolpropane were individually dissolved in ion-exchanged water into 10% aqueous solutions for measurement of their surface tensions.

Surface tensions (mN/m) of the ink compositions in Tables 1 and 2 were measured at 20° with the same apparatus as used in the measurement of the surface tensions of the organic solvents.

In particular, the components shown in Tables 1 and 2 are as follows:

Colorant: cyan pigment (Pigment Blue 15:3), black pigment (Carbon Black), silver pigment (silver particles);
Organic solvents: 2-ethyl-1,3-hexanediol, 1,2-hexanediol, tetraethylene glycol monobutyl ether, polyethylene glycol #400 (name of a product manufactured by NACALAI TESQUE, INC., molecular weight of 380 to 420), dipropylene glycol, 1,5-pentanediol, glycerin, 1,6-hexanediol, trimethylolpropane (surfactant), BKY-348 (name of a product manufactured by BYE Japan KK, polysiloxane surfactant); and
Other components: triethanolamine (pH adjuster), and ion-exchanged water.

The silver particles were prepared as follows. Polyvinylpyrrolidone (PVP) (weight-average molecular weight of 10000) was heated at 70° C. for 15 hours and then cooled at room temperature.

The PVP (1000 g) was added to ethylene glycol (500 ml) to prepare a PVP solution. Ethylene glycol (500 ml) and silver nitrate (128 g) were put into another container and then sufficiently stirred with an electromagnetic stirrer to prepare a silver nitrate solution. The silver nitrate solution was added to the PVP solution while the PVP solution was stirred at 120° with an overhead mixer, and the mixed solution was heated for approximately 80 minutes to promote a reaction. The solution was then cooled at room temperature. The resulting solution was subjected to centrifugal separation with a centrifugal separator at 2200 rpm for 10 minutes. Then, the separated silver particles were recovered and then added to ethanol (500 ml) to remove unnecessary PVP. The resulting product was further subjected to centrifugal separation to recover the silver particles. The recovered silver particles were dried with a vacuum drier at 35° C. and 1.3 Pa. In this manner, the silver particles were produced.

In preparation of the ink composition containing the silver particles, a silver particle dispersion preliminarily prepared by dispersing the silver particles in water was used. In particular, the silver particles obtained as described above were added to pure water, and the resulting product was stirred for three hours to redisperse the silver particles, thereby preparing an aqueous dispersion of the silver particles as a dispersion of 20% solid content.

The cyan pigment and the black pigment were dispersed as follows. Water-soluble resin (synthesized by copolymerization of methacrylate, butyl acrylate, styrene, and hydroxyethyl acrylate in a mass ratio of 25:50:15:10, weight-average molecular weight of 12,000, and 40 parts by weight) was added to a mixed solution of potassium hydroxide (7 parts by weight), water (23 parts by weight), and triethylene glycol mono-n-butyl ether (30 parts by weight) and then heated at 80° C. while being stirred for dissolution to prepare a water-soluble resin solution. The solution (1.75 kg, 43% solid content) was mixed with the pigment shown in Tables 1 and 2 (3.0 kg), ethylene glycol (1.5 kg), and water (8.75 kg), and then the mixture was stirred with a mixing machine for pre-mixing. The liquid mixture containing the pigment was dispersed with a horizontal bead mill through a multi-pass process, the horizontal bead mill being filled by 85% with zirconia beads (0.5 mm), having an effective volume of 1.5 liters, and being equipped with an impeller having multiple disks. In particular, the dispersion was carried out through two pass processes at a peripheral speed of 8 m/second and ejection rate of 30 liters/hour to produce a liquid mixture containing the pigment. Then, circular dispersion was carried out with an annular bead mill having an effective volume of 1.5 liters, the horizontal bead mill being filled by 95% with zirconia beads (0.05 mm). A 0.015 mm screen was used, and the liquid mixture containing the pigment (10 kg) was dispersed for 4 hours at a peripheral speed of 10 m/second and circular rate of 300 liters/hour to produce a pigment dispersion containing a 20% solid content as a pigment.

TABLE 1

| | | Example | | | | | | | |
|---|---|---|---|---|---|---|---|---|---|
| Ink composition | | 1 | 2 | 3 | 4 | 5 | 6 | 7 | 8 |
| Colorant | Cyan pigment | 5 | 5 | 5 | 5 | 5 | 5 | 5 | 5 |
| | Black pigment | | | | | | | | |
| | Silver pigment | | | | | | | | |
| Organic solvent | 2-ethyl-1,3-hexanediol (29) | 0.5 | | | | | | | |
| | 1,2-hexanediol (27) | | 0.5 | | 2.5 | | 5 | | |
| | Tetraethylene glycol | | | 0.5 | | 2.5 | | 5 | |
| | monobutyl ether (28) | | | | | | | | |
| | Polyethylene glycol | | | | | | | | |
| | #400 (31) | | | | | | | | |
| | Dipropylene glycol (32) | | | | | | | | |
| | 1,5-pentanediol (43) | | | | | | | | |
| | Glycerin (63.4) | | | | | | | | |
| | 1,6-hexanediol (43.6; | 5 | | | | | | | 5 |
| | 10% aqueous solution) | | | | | | | | |
| | Trimethylolpropane | 10 | 10 | 10 | 10 | 10 | 10 | 10 | 10 |
| | (58.5; 10% aqueous | | | | | | | | |
| | solution) | | | | | | | | |
| Surfactant | BYK-348 | 0.5 | 0.5 | 0.5 | 0.5 | 0.5 | 0.5 | 0.5 | 0.5 |
| Other | Triethanolamine | 0.5 | 0.5 | 0.5 | 0.5 | 0.5 | 0.5 | 0.5 | 0.5 |
| components | Ion-exchanged water | Balance | Balance | Balance | Balance | Balance | Balance | Balance | Balance |
| Total (mass %) | | 100 | 100 | 100 | 100 | 100 | 100 | 100 | 100 |
| Physical | Surface tension of ink | 29 | 31 | 31 | 30 | 31 | 30 | 31 | 30 |
| property of ink | composition (mN/m) | | | | | | | | |
| Evaluation test | Ejection stability | A | A | A | A | A | A | A | A |
| | (recording head A) | | | | | | | | |
| | Ejection stability | A | B | B | B | A | A | B | C |
| | (recording head B) | | | | | | | | |

| | | Example | | | | | | |
|---|---|---|---|---|---|---|---|---|
| Ink composition | | 9 | 10 | 11 | 12 | 13 | 14 | 15 |
| Colorant | Cyan pigment | | | 5 | 5 | 5 | 5 | 5 |
| | Black pigment | 2 | | | | | | |
| | Silver pigment | | 10 | | | | | |
| Organic solvent | 2-ethyl-1,3-hexanediol (29) | 0.5 | 0.5 | 0.2 | | | 0.015 | |
| | 1,2-hexanediol (27) | | | | 2.5 | 2.5 | | |
| | Tetraethylene glycol | | | | | 2.5 | | |
| | monobutyl ether (28) | | | | | | | |
| | Polyethylene glycol | | | | | | | |
| | #400 (31) | | | | | | | |
| | Dipropylene glycol (32) | | | | | | | |
| | 1,5-pentanediol (43) | | | | | | | |
| | Glycerin (63.4) | | | | | | | |
| | 1,6-hexanediol (43.6; | 5 | 5 | 2 | 2.5 | | 0.15 | 0.15 |
| | 10% aqueous solution) | | | | | | | |
| | Trimethylolpropane | 10 | 10 | 10 | 10 | 10 | 10 | 10 |
| | (58.5; 10% aqueous | | | | | | | |
| | solution) | | | | | | | |
| Surfactant | BYK-348 | 0.5 | 0.5 | 0.5 | 0.5 | 0.5 | 0.5 | 0.5 |
| Other | Triethanolamine | 0.5 | 0.5 | 0.5 | 0.5 | 0.5 | 0.5 | 0.5 |
| components | Ion-exchanged water | Balance | Balance | Balance | Balance | Balance | Balance | Balance |
| Total (mass %) | | 100 | 100 | 100 | 100 | 100 | 100 | 100 |
| Physical | Surface tension of ink | 31 | 31 | 30 | 30 | 30 | 30 | 31 |
| property of ink | composition (mN/m) | | | | | | | |
| Evaluation test | Ejection stability | A | A | A | A | A | A | A |
| | (recording head A) | | | | | | | |
| | Ejection stability | A | A | B | A | A | C | C |
| | (recording head B) | | | | | | | |

TABLE 2

| | | Comparative Example | | | | | | |
|---|---|---|---|---|---|---|---|---|
| Ink composition | | 1 | 2 | 3 | 4 | 5 | 6 | 7 |
| Colorant | Cyan pigment | 5 | 5 | 5 | 5 | 5 | 5 | 5 |
| | Black pigment | | | | | | | |
| | Silver pigment | | | | | | | |
| Organic solvent | 2-ethyl-1,3-hexanediol (29) | | | | | | 0.1 | |
| | 1,2-hexanediol (27) | | | | | | | |
| | Tetraethylene glycol monobutyl ether (28) | | | | | | | |
| | Polyethylene glycol #400 (31) | 5 | | | | | | |
| | Dipropylene glycol (32) | | 5 | | | | | |
| | 1,5-pentanediol (43) | | | 5 | | | | |
| | Glycerin (63.4) | | | | 5 | 5 | 5 | |
| | 1,6-hexanediol (43.6; 10% aqueous | | | | | | | 0.1 |
| | solution) | | | | | | | |
| | Trimethylolpropane (58.5; 10% aqueous | 10 | 10 | 10 | 10 | 10 | 10 | 10 |
| | solution) | | | | | | | |
| Surfactant | BYK-348 | 0.5 | 0.5 | 0.5 | 0.5 | 3 | 0.5 | 0.5 |
| Other | Triethanolamine | 0.5 | 0.5 | 0.5 | 0.5 | 0.5 | 0.5 | 0.5 |
| components | Ion-exchanged water | Balance | Balance | Balance | Balance | Balance | Balance | Balance |
| Total (mass %) | | 100 | 100 | 100 | 100 | 100 | 100 | 100 |
| Physical | Surface tension of ink composition (mN/m) | 28 | 31 | 32 | 31 | 22 | 30 | 30 |
| property of ink | | | | | | | | |
| Evaluation test | Ejection stability (print head A) | A | A | A | A | A | A | A |
| | Ejection stability (print head B) | D | D | D | D | D | D | D |

### 3.2. Ink Jet Printer

An ink jet printer A (hereinafter referred to as “printer A”, where appropriate) and an ink jet printer B (hereinafter referred to as “printer B”, where appropriate) were used for the following evaluation test.

The printer A had a configuration in which an ink jet printer PX-G930 (manufactured by SEIKO EPSON CORPORATION) was provided with a recording head A. The recording head A had nozzles having a tapered structure in which the diameter of the nozzles became decreased in a direction of ejection of ink droplets, the recording head A being formed by eutectoid plating of nickel and polytetrafluoroethylene. The recording head A had a nozzle density of 180 dpi.

The printer B had a configuration in which an ink jet printer PX-H8000 (manufactured by SEIKO EPSON CORPORATION) was provided with a recording head B. The recording head B had nozzles having a structure in which the diameter of the nozzles became decreased stepwise in a direction of ejection of ink droplets (as in nozzle having the step illustrated in FIG. 4) and was composed of monocrystalline silicon. The recording head B had a nozzle density of 360 dpi.

The ink compositions shown in Tables 1 and 2 were used to fill original ink cartridges of the printers A and B. The ink cartridges were attached to nozzle lines of Photo Black in the printers A and B, and commercially available ink cartridges were attached to the other nozzle lines. The commercially available ink cartridges attached to the nozzle lines other than the nozzle lines of Photo Black were dummy cartridges and were not herein used for evaluation, which did not had any influence on results of the evaluation.

### 3.3. Evaluation Test of Ejection Stability

### 3.3.1. Production of Evaluation Sample

The printers A and B were used to carry out continuous printing on 100 sheets of Photo Paper Glossy (name of a product manufactured by SEIKO EPSON CORPORATION, A4 size) at 35° C. and 35% relative humidity (RH) to produce recorded materials (evaluation samples) on which solid images were printed. The printing was carried out at an image resolution of 1440×1440 dpi and 100% Duty.

The term “Duty” was a value determined from the following formula.

Duty (%)=number of actually printed dots/(vertical resolution×horizontal resolution)×100

In the formula, the term “number of actually printed dots” indicates number of actually printed dots per unit area, and the terms “vertical resolution” and “horizontal resolution” indicate resolution in unit directions.

### 3.3.2. Evaluation Test

The evaluation samples were visually observed to confirm presence or absence of a defective printing portion, thereby evaluating ejection stability of inks. Evaluation criteria are as follows. Results of the evaluation are shown in Tables 1 and 2.

AA: No defective printing portion;
A: One defective printing portion;
B: Two to three defective printing portions;
C: Four to five defective printing portions; and
D: At least six defective printing portions.

### 3.4. Results of Evaluation

Table 1 demonstrates that the ink compositions of Examples 1 to 15 exhibited excellent ejection stability.

In contrast, since the ink compositions of Comparative Examples 1 to 5 did not contain the first water-soluble organic solvent and the second water-soluble organic solvent, Table 2 shows the results of the evaluation of ejection stability in which unsatisfactory ejection stability was exhibited in use of the printer B provided with the recording head B.

The ink composition of Comparative Example 6 did not contain the second water-soluble organic solvent while containing a component corresponding to the first water-soluble organic solvent in an amount less than 0.15 mass %. Thus, Table 2 shows the result of the evaluation of ejection stability in which unsatisfactory ejection stability was exhibited in use of the printer B provided with the recording head B.

The ink composition of Comparative Example 7 did not contain the first water-soluble organic solvent while containing a component corresponding to the second water-soluble organic solvent in an amount less than 0.15 mass %. Thus, Table 2 shows the result of the evaluation of ejection stability in which unsatisfactory ejection stability was exhibited in use of the printer B provided with the recording head B.

The invention should not be limited to the above embodiments and can be variously modified. For example, the invention may include configurations substantially the same as those of the above embodiments (e.g., configurations having the same functions, processes, and results or configurations having the same advantages and effects). The invention may include configurations provided by changing non-essential parts of the configurations described in the above embodiments. The invention may include other configurations which provide the same advantages and effects as those described in the above embodiments. The invention may include configurations in which a traditional technique is added to the configurations described in the above embodiments.

What is claimed is:

1. An ink composition ejected from a nozzle having a step, the ink composition comprising:
at least any one of a first water-soluble organic solvent and a second water-soluble organic solvent, wherein
the first water-soluble organic solvent exhibits a surface tension of not more than 30 mN/m at 20° C.,
an aqueous solution of the second water-soluble organic solvent of 10 mass % exhibits a surface tension of not more than 50 mN/m at 20° C., and
the total content of the first water-soluble organic solvent and the second water-soluble organic solvent is not less than 0.15 mass %.

2. The ink composition according to claim 1, wherein the nozzle is formed in a nozzle plate, and the nozzle plate is composed of crystalline silicon.

3. The ink composition according to claim 2, wherein the nozzle plate is included in a recording head, and the recording head has a nozzle density of 300 dpi or higher and is a piezoelectric type.

4. The ink composition according to claim 1, further comprising at least one different first water-soluble organic solvent.

5. The ink composition according to claim 1, wherein the first water-soluble organic solvent is at least any one of 2-ethyl-1,3-hexanediol and 1,2-hexanediol.

6. A recording unit comprising:
the ink composition according to claim 1; and
a recording head; and
a nozzle formed in the recording head and having a step, wherein
the ink composition is ejected from the nozzle.

7. A recording unit comprising:
the ink composition according to claim 2; and
a recording head; and
a nozzle formed in the recording head and having a step, wherein
the ink composition is ejected from the nozzle.

8. A recording unit comprising:
the ink composition according to claim 3; and
a recording head; and
a nozzle formed in the recording head and having a step, wherein
the ink composition is ejected from the nozzle.

9. A recording unit comprising:
the ink composition according to claim 4; and
a recording head; and
a nozzle formed in the recording head and having a step, wherein
the ink composition is ejected from the nozzle.

10. A recording unit comprising:
the ink composition according to claim 5; and
a recording head; and
a nozzle formed in the recording head and having a step, wherein
the ink composition is ejected from the nozzle.

11. An ink jet recording apparatus comprising:
a nozzle having a step, wherein
the ink composition according to claim 1 is ejected from the nozzle for recording.

12. An ink jet recording apparatus comprising:
a nozzle having a step, wherein
the ink composition according to claim 2 is ejected from the nozzle for recording.

13. An ink jet recording apparatus comprising:
a nozzle having a step, wherein
the ink composition according to claim 3 is ejected from the nozzle for recording.

14. An ink jet recording apparatus comprising:
a nozzle having a step, wherein
the ink composition according to claim 4 is ejected from the nozzle for recording.

15. An ink jet recording apparatus comprising:
a nozzle having a step, wherein
the ink composition according to claim 5 is ejected from the nozzle for recording.

16. A recorded material formed by using the ink jet recording apparatus according to claim 11.

17. A recorded material formed by using the ink jet recording apparatus according to claim 12.

18. A recorded material formed by using the ink jet recording apparatus according to claim 13.

19. A recorded material formed by using the ink jet recording apparatus according to claim 14.

20. A recorded material formed by using the ink jet recording apparatus according to claim 15.
